(19) United States
(12) Patent Application Publication
(10) Pub. No.: US 2013/0043735 A1
(43) Pub. Date: Feb. 21, 2013

(54) SYSTEMS, METHODS, AND DEVICES FOR MULTI-LEVEL SIGNALING VIA A WIRELESS POWER TRANSFER FIELD

(71) Applicants: Zhen Ning Low, San Diego, CA (US); Sergio Perez Estrada, San Diego, CA (US)

(72) Inventors: Zhen Ning Low, San Diego, CA (US); Sergio Perez Estrada, San Diego, CA (US)

(73) Assignee: QUALCOMM Incorporated, San Diego, CA (US)

(21) Appl. No.: 13/464,863

(22) Filed: May 4, 2012

Related U.S. Application Data
(60) Provisional application No. 61/524,289, filed on Aug. 16, 2011.

(51) Int. Cl. H02J 17/00

(52) U.S. Cl. 307/104

(57) ABSTRACT

Systems, methods and apparatus are disclosed for signaling between wireless power transmitters and receivers. In one aspect a wireless power receiver is disclosed. The wireless power receiver includes an antenna circuit characterized by an impedance. The antenna circuit is configured to wirelessly receive power for powering or charging a load. The wireless power receiver further includes an impedance adjustment circuit configured to communicate multi-level signaling data values to a wireless power transmitter coupled to the receiver. The wireless power transmitter includes a controller configured to receive a signal indicative of a change in receiver impedance and determine the multi-level signaling data values based on the detected change.

### CROSS REFERENCE TO RELATED APPLICATIONS

This application claims priority benefit under 35 U.S.C. §119(e) to U.S. Provisional Patent Application No. 61/524,289 entitled “IMPEDANCE CONTROLLED PHASE SHIFT MODULATION” filed on Aug. 16, 2011, the disclosure of which is hereby incorporated by reference in its entirety.

### FIELD

The present invention relates generally to wireless power. More specifically, the disclosure is directed to communicating multi-level signaling data values to a wireless power transmitter through impedance adjustment of a wireless power receiver.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power. As such, these devices constantly require recharging. Rechargeable devices are often charged via wired connections through cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices or provide power to electronic devices may overcome some of the deficiencies of wired charging solutions. As such, wireless power transfer systems and methods that efficiently and safely transfer power to electronic devices are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a wireless power receiver configured to receive power from and communicate with a wireless power transmitter via a wireless field, the wireless power receiver including a resonant circuit having a receiver impedance capable of being sensed by the transmitter, and an impedance adjustment circuit configured to adjust the receiver impedance to transmit multi-level signaling data values to the transmitter.

According to another aspect, a method for receiving power via a wireless field is disclosed. The method includes receiving power via a wireless field with a wireless power receiver from a wireless power transmitter for powering or charging a load, and adjusting an impedance of the wireless power receiver to communicate multi-level signaling data values to the wireless power transmitter.

According to another aspect, a wireless power receiver is disclosed. The wireless power receiver includes means for receiving power via a wireless field with a wireless power receiver from a wireless power transmitter for powering or charging a load, and means for adjusting an impedance of the wireless power receiver to communicate multi-level signaling data values to the wireless power transmitter.

According to another aspect, a wireless power transmitter is disclosed. The wireless power transmitter is configured to transmit power to and communicate with a wireless power receiver via a wireless field, the wireless power receiver having an resonant circuit having a wireless power receiver impedance. The wireless power transmitter includes an impedance detection circuit configured to detect a change in the wireless power receiver impedance, and a processor configured to determine multi-level signaling data values based on the change in the wireless power receiver impedance.

According to another aspect, a method of transmitting power via a wireless field is disclosed. The method includes detecting a change in impedance of a wireless power transmit circuit configured to wirelessly transmit power, and determining multi-level signaling data values based on the change in impedance.

According to another aspect, a wireless power transmitter is disclosed. The wireless power transmitter includes means for detecting a change in impedance of a wireless power transmit circuit configured to wirelessly transmit power, and means for determining multi-level signaling data values based on the change in impedance.

### BRIEF DESCRIPTION OF THE DRAWINGS

FIG. 1 is a functional block diagram of an example wireless power transfer system according to some embodiments.

FIG. 2 is a functional block diagram of example components that may be used in the wireless power transfer system of FIG. 1 according to some embodiments.

FIG. 3 is a schematic diagram of a portion of transmit circuitry or receive circuitry of FIG. 2 including a transmit or receive coil according to some embodiments.

FIG. 4 is a functional block diagram of a transmitter that may be used in the wireless power transfer system of FIG. 1 according to some embodiments.

FIG. 5 is a functional block diagram of a receiver that may be used in the wireless power transfer system of FIG. 1 according to some embodiments.

FIG. 6 is a schematic diagram of a portion of transmit circuitry that may be used in the transmit circuitry of FIG. 4.

FIG. 7 illustrates a schematic diagram of a wireless power transmitter and wireless power receiver.

FIG. 8 is a plot showing transmitter output power as a function of various loads.

FIG. 9 is a plot showing a transmitter impedance response as a function of various loads.

FIG. 10 shows a partial schematic diagram of a wireless power receiver including an impedance adjustment circuit according to some embodiments.

FIG. 11 shows a graph of an example waveform envelope at an output of a driver of a wireless power transmitter.

FIG. 12A illustrates an example of an on-off keying signaling waveform according a conventional signaling system.

FIG. 12B illustrates an example of a ternary modulation waveform according to some embodiments.

FIG. 13A illustrates another example of an on-off keying signaling waveform according to a conventional signaling system.

FIG. 13B illustrates an example of a quinary modulation waveform according to some embodiments.

FIG. 14A illustrates an example of a pulse position modulation signaling waveform according a conventional signaling system.

FIG. 14B illustrates an example of a binary pulse position modulation waveform according to some embodiments.

FIG. 14C illustrates an example of a differential pulse position modulation waveform according to some embodiments.

FIG. 15 illustrates a flow chart of an example method for receiving multi-level signaling data values according to some embodiments.

FIG. 16 illustrates a flow chart of an example method for generating multi-level signaling data values according to some embodiments.

FIG. 17 is a functional block diagram of an apparatus for receiving multi-level signaling data values according to some embodiments.

FIG. 18 is a functional block diagram of an apparatus for generating multi-level signaling data values according to some embodiments.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of some embodiments of the invention and is not intended to represent the only embodiments in which the invention may be practiced. The term “exemplary” used throughout this description means “serving as an example, instance, or illustration,” and should not necessarily be construed as preferred or advantageous over other embodiments. The detailed description includes specific details for the purpose of providing a thorough understanding of the embodiments of the invention. The embodiments of the invention may be practiced without these specific details. In some instances, well-known structures and devices are shown in block diagram form in order to avoid obscuring the novelty of the embodiments presented herein.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer.

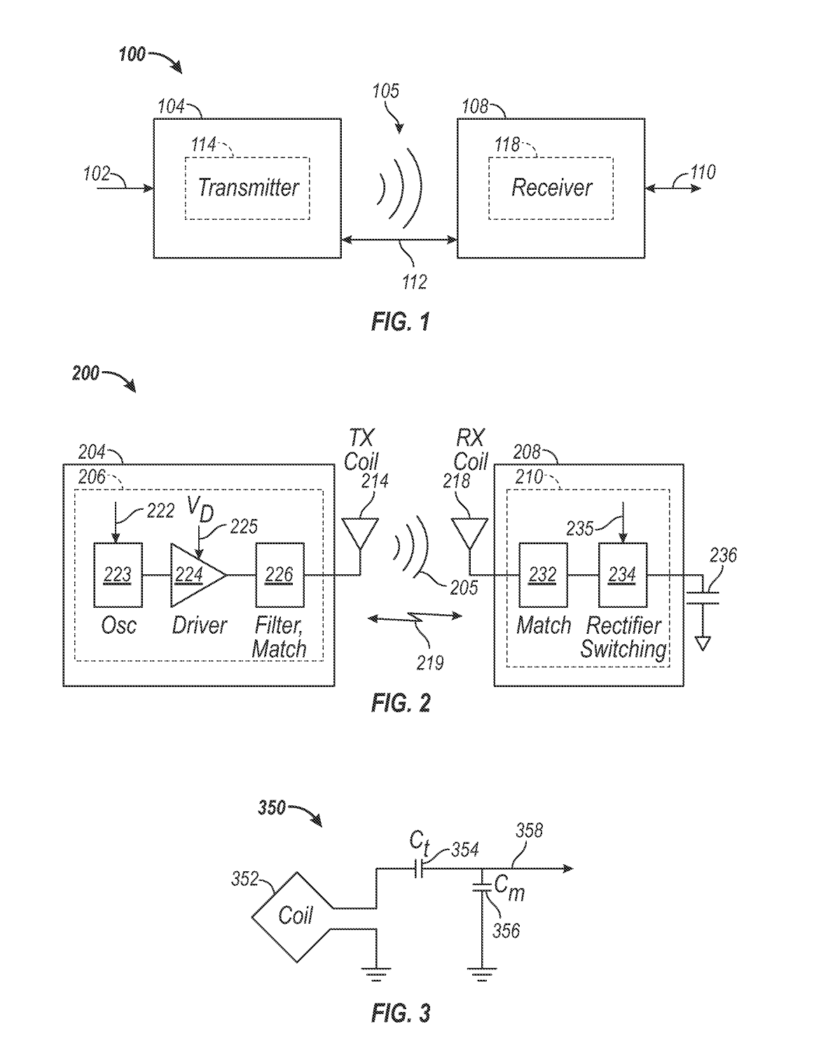

FIG. 1 is a functional block diagram of an example wireless power transfer system 100 according to some embodiments. Input power 102 may be provided to a transmitter 104 from a power source (not shown) for generating a field 105 for providing energy transfer. A receiver 108 may couple to the field 105 and generate output power 110 for storing or consumption by a device (not shown) coupled to the output power 110. Both the transmitter 104 and the receiver 108 are separated by a distance 112. In one embodiment, transmitter 104 and receiver 108 are configured according to a mutual resonant relationship. When the resonant frequency of receiver 108 and the resonant frequency of transmitter 104 are substantially the same or very close, transmission losses between the transmitter 104 and the receiver 108 are minimal. As such, wireless power transfer may be provided over larger distance in contrast to purely inductive solutions that may require large coils that require coils to be very close (e.g., mms). Resonant inductive coupling techniques may thus allow for improved efficiency and power transfer over various distances and with a variety of inductive coil configurations.

The receiver 108 may receive power when the receiver 108 is located in an energy field 105 produced by the transmitter 104. The field 105 corresponds to a region where energy output by the transmitter 104 may be captured by a receiver 105. In some cases, the field 105 may correspond to the “near-field” of the transmitter 104 as will be further described below. The transmitter 104 may include a transmit coil 114 for outputting an energy transmission. The receiver 108 further includes a receive coil 118 for receiving or capturing energy from the energy transmission. The near-field may correspond to a region in which there are strong reactive fields resulting from the currents and charges in the transmit coil 114 that minimally radiate power away from the transmit coil 114. In some cases the near-field may correspond to a region that is within about one wavelength (or a fraction thereof) of the transmit coil 114. The transmit and receive coils 114 and 118 are sized according to applications and devices to be associated therewith. As described above, efficient energy transfer may occur by coupling a large portion of the energy in a field 105 of the transmit coil 114 to a receive coil 118 rather than propagating most of the energy in an electromagnetic wave to the far field. When positioned within the field 105, a “coupling mode” may be developed between the transmit coil 114 and the receive coil 118. The area around the transmit and receive coils 114 and 118 where this coupling may occur is referred to herein as a coupling-mode region.

FIG. 2 is a functional block diagram of example components that may be used in the wireless power transfer system 100 of FIG. 1 according to some embodiments. The transmitter 204 may include transmit circuitry 206 that may include an oscillator 222, a driver 224, and a filter and matching circuit 226. The oscillator 222 may be configured to generate a signal at a desired frequency, such as 468.75 KHz, 6.78 MHz or 13.56 MHz, that may be adjusted in response to a frequency control signal 223. The oscillator signal may be provided to a driver 224 configured to drive the transmit coil 214 at, for example, a resonant frequency of the transmit coil 214. The driver 224 may be a switching amplifier configured to receive a square wave from the oscillator 222 and output a sine wave. For example, the driver 224 may be a class E amplifier. A filter and matching circuit 226 may be also included to filter out harmonics or other unwanted frequencies and match the impedance of the transmitter 204 to the transmit coil 214.

The receiver 208 may include receive circuitry 210 that may include a matching circuit 232 and a rectifier and switching circuit 234 to generate a DC power output from an AC power input to charge a battery 236 as shown in FIG. 2 or to power a device (not shown) coupled to the receiver 108. The matching circuit 232 may be included to match the impedance of the receive circuitry 210 to the receive coil 218. The receiver 208 and transmitter 204 may additionally communicate on a separate communication channel 219 (e.g., Bluetooth, zigbee, cellular, etc). The receiver 208 and transmitter 204 may alternatively communicate via in-band signaling using characteristics of the wireless field 206.

As described more fully below, receiver 208, that may initially have an associated load (e.g., battery 236) that is capable of being selectively disabled. The receiver 208 may be configured to determine whether an amount of power transmitted by transmitter 204 and receiver by receiver 208 is appropriate for charging a battery 236. Further, receiver 208 may be configured to enable a load (e.g., battery 236) upon determining that the amount of power is appropriate. In some embodiments, a receiver 208 may be configured to directly utilize power received from a wireless power transfer field without charging of a battery 236. For example, a communication device, such as a near-field communication (NFC) or radio-frequency identification device (RFID may be configured to receive power from a wireless power transfer field and communicate by interacting with the wireless power transfer field and/or utilize the received power to communicate with a transmitter 204 or other devices.

FIG. 3 is a schematic diagram of a portion of transmit circuitry 206 or receive circuitry 210 of FIG. 2 including a transmit or receive coil 352 according to some embodiments. As illustrated in FIG. 3, transmit or receive circuitry 350 used in some embodiments may include a coil 352. The coil may also be referred to or be configured as a “loop” antenna 352. The coil 352 may also be referred to herein or be configured as a “magnetic” antenna or an induction coil. The term “coil” is intended to refer to a component that may wirelessly output or receive energy for coupling to another “coil.” The coil may also be referred to as an “antenna” of a type that is configured to wirelessly output or receive power. The coil 352 may be configured to include an air core or a physical core such as a ferrite core (not shown). Air core loop coils may be more tolerable to extraneous physical devices placed in the vicinity of the core. Furthermore, an air core loop coil 352 allows the placement of other components within the core area. In addition, an air core loop may more readily enable placement of the receive coil 218 (FIG. 2) within a plane of the transmit coil 214 (FIG. 2) where the coupled-mode region of the transmit coil 214 (FIG. 2) may be more powerful.

As stated, efficient transfer of energy between the transmitter 104 and receiver 108 may occur during matched or nearly matched resonance between the transmitter 104 and the receiver 108. However, even when resonance between the transmitter 104 and receiver 108 are not matched, energy may be transferred, although the efficiency may be affected. Transfer of energy occurs by coupling energy from the field 105 of the transmitting coil to the receiving coil residing in the neighborhood where this field 105 is established rather than propagating the energy from the transmitting coil into free space.

The resonant frequency of the loop or magnetic coils is based on the inductance and capacitance. Inductance may be simply the inductance created by the coil 352, whereas, capacitance may be added to the coil's inductance to create a resonant structure at a desired resonant frequency. As a non-limiting example, capacitor 352 and capacitor 354 may be added to the transmit or receive circuitry 350 to create a resonant circuit that selects a signal 356 at a resonant frequency. Accordingly, for larger diameter coils, the size of capacitance needed to sustain resonance may decrease as the diameter or inductance of the loop increases. Furthermore, as the diameter of the coil increases, the efficient energy transfer area of the near-field may increase. Other resonant circuits formed using other components are also possible. As another non-limiting example, a capacitor may be placed in parallel between the two terminals of the coil 350. For transmit coils, a signal 358 with a frequency that substantially corresponds to the resonant frequency of the coil 352 may be an input to the coil 352.

In one embodiment, the transmitter 104 may be configured to output a time varying magnetic field with a frequency corresponding to the resonant frequency of the transmit coil 114. When the receiver is within the field 105, the time varying magnetic field may induce a current in the receive coil 118. As described above, if the receive coil 118 is configured to be resonant at the frequency of the transmit coil 118, energy may be efficiently transferred. The AC signal induced in the receive coil 118 may be rectified as described above to produce a DC signal that may be provided to charge or to power a load.

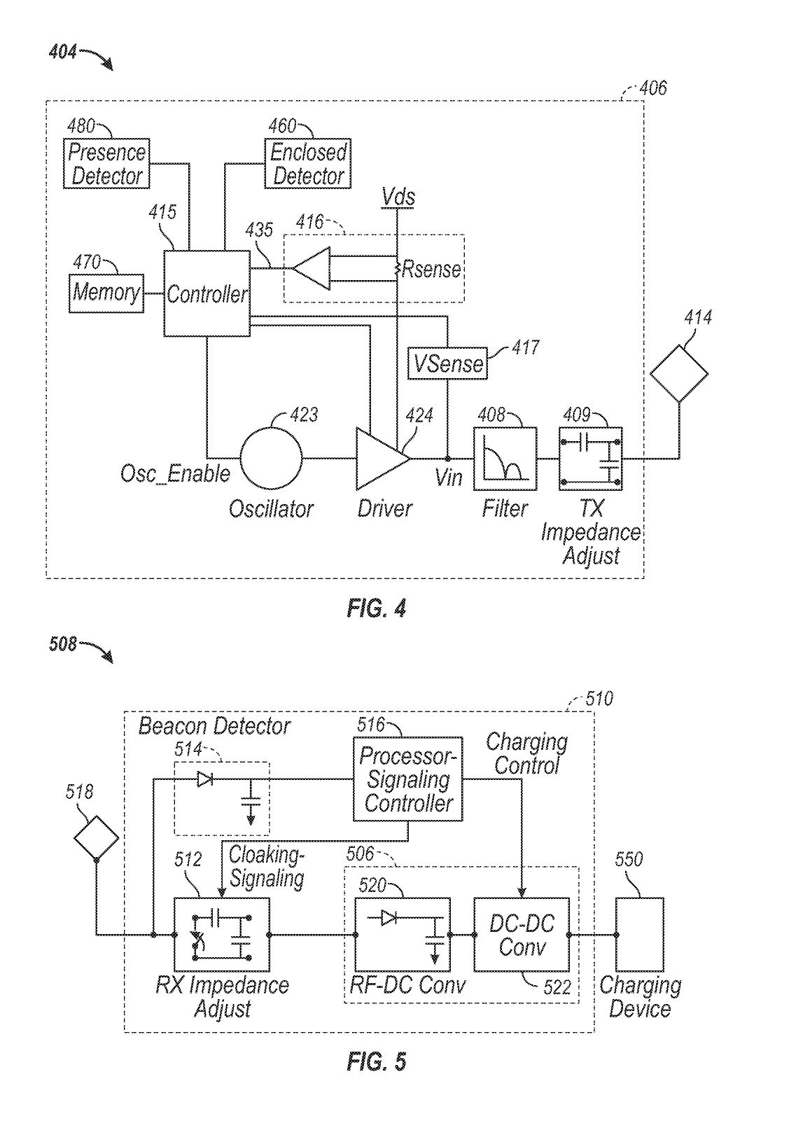

FIG. 4 is a functional block diagram of a transmitter 404 that may be used in the wireless power transfer system of FIG. 1 according to some embodiments. The transmitter 404 may include transmit circuitry 406 and a transmit coil 414. The transmit coil 414 may be the coil 352 as shown in FIG. 3. Transmit circuitry 406 may provide RF power to the transmit coil 414 by providing an oscillating signal resulting in generation of energy (e.g., magnetic flux) about the transmit coil 414. Transmitter 404 may operate at any suitable frequency. By way of example, transmitter 404 may operate at the 13.56 MHz ISM band.

Transmit circuitry 406 may include a fixed impedance matching circuit 409 for matching the impedance of the transmit circuitry 406 (e.g., 50 ohms) to the transmit coil 414 and a low pass filter (LPF) 408 configured to reduce harmonic emissions to levels to prevent self-jamming of devices coupled to receivers 108 (FIG. 1). Other embodiments may include different filter topologies, including but not limited to, notch filters that attenuate specific frequencies while passing others and may include an adaptive impedance match, that may be varied based on measurable transmit metrics, such as output power to the coil 414 or DC current drawn by the driver 424. Transmit circuitry 406 further includes a driver 424 configured to drive an RF signal as determined by an oscillator 423. The transmit circuitry 406 may be comprised of discrete devices or circuits, or alternately, may be comprised of an integrated assembly. An RF power output from transmit coil 414 may be on the order of 2.5 Watts.

Transmit circuitry 406 may further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 may also be referred to herein as processor 415. Adjustment of oscillator phase and related circuitry in the transmission path may allow for reduction of out of band emissions, especially when transitioning from one frequency to another.

The transmit circuitry 406 may further include a load sensing circuit 416 for detecting the presence or absence of active receivers in the vicinity of the near-field generated by transmit coil 414. By way of example, a load sensing circuit 416 monitors the current flowing to the driver 424, that may be affected by the presence or absence of active receivers in the vicinity of the field generated by transmit coil 414 as will be further described below. Detection of changes to the loading on the driver 424 are monitored by controller 415 for use in determining whether to enable the oscillator 423 for transmitting energy and to communicate with an active receiver.

The transmit coil 414 may be implemented with a Litz wire or as an antenna strip with the thickness, width and metal type selected to keep resistive losses low. In a one implementation, the transmit coil 414 may generally be configured for association with a larger structure such as a table, mat, lamp or other less portable configuration. Accordingly, the transmit coil 414 generally may not need “turns” in order to be of a practical dimension. An implementation of a transmit coil 414 may be “electrically small” (i.e., fraction of the wavelength) and tuned to resonate at lower usable frequencies by using capacitors to define the resonant frequency.

The transmitter 404 may gather and track information about the whereabouts and status of receiver devices that may be associated with the transmitter 404. Thus, the transmit circuitry 406 may include a presence detector 480, an enclosed detector 460, or a combination thereof, connected to the controller 415 (also referred to as a processor herein). The controller 415 may adjust an amount of power delivered by the driver 424 in response to presence signals from the presence detector 480 and the enclosed detector 460. The transmitter 404 may receive power through a number of power sources, such as, for example, an AC-DC converter (not shown) to convert conventional AC power present in a building, a DC-DC converter (not shown) to convert a conventional DC power source to a voltage suitable for the transmitter 404, or directly from a conventional DC power source (not shown).

As a non-limiting example, the presence detector 480 may be a motion detector utilized to sense the initial presence of a device to be charged that is inserted into the coverage area of the transmitter 404. After detection, the transmitter 404 may be turned on and the RF power received by the device may be used to toggle a switch on the Rx device in a pre-determined manner, which in turn results in changes to the driving point impedance of the transmitter 404.

As another non-limiting example, the presence detector 480 may be a detector capable of detecting a human, for example, by infrared detection, motion detection, or other suitable means. In some embodiments, there may be regulations limiting the amount of power that a transmit coil 414 may transmit at a specific frequency. In some cases, these regulations are meant to protect humans from electromagnetic radiation. However, there may be environments where a transmit coil 414 is placed in areas not occupied by humans, or occupied infrequently by humans, such as, for example, garages, factory floors, shops, and the like. If these environments are free from humans, it may be permissible to increase the power output of the transmit coil 414 above the normal power restrictions regulations. In other words, the controller 415 may adjust the power output of the transmit coil 414 to a regulatory level or lower in response to human presence and adjust the power output of the transmit coil 414 to a level above the regulatory level when a human is outside a regulatory distance from the electromagnetic field of the transmit coil 414.

As a non-limiting example, the enclosed detector 460 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

According to some embodiments, a method by which the transmitter 404 does not remain on indefinitely may be used. In this case, the transmitter 404 may be programmed to shut off after a user-determined amount of time. This feature prevents the transmitter 404, notably the driver 424, from running long after the wireless devices in its perimeter are fully charged. This event may be due to the failure of the circuit to detect the signal sent from either the repeater or the receive coil that a device is fully charged. To prevent the transmitter 404 from automatically shutting down if another device is placed in its perimeter, the transmitter 404 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

FIG. 5 is a functional block diagram of a receiver 508 that may be used in the wireless power transfer system of FIG. 1 according to some embodiments. The receiver 508 includes receive circuitry 510 that may include a receive coil 518. Receiver 508 further couples to device 550 for providing received power thereto. It should be noted that receiver 508 is illustrated as being external to device 550 but may be integrated into device 550. Energy may be propagated wirelessly to receive coil 518 and then coupled through the rest of the receive circuitry 510 to device 550. By way of example, the charging device may include devices such as mobile phones, portable music players, laptop computers, tablet computers, computer peripheral devices, communication devices (e.g., Bluetooth devices), digital cameras, hearing aids (an other medical devices), and the like.

Receive coil 518 may be tuned to resonate at the same frequency, or within a specified range of frequencies, as transmit coil 414 (FIG. 4). Receive coil 518 may be similarly dimensioned with transmit coil 414 or may be differently sized based upon the dimensions of the associated device 550. By way of example, device 550 may be a portable electronic device having diametric or length dimension smaller that the diameter of length of transmit coil 414. In such an example, receive coil 518 may be implemented as a multi-turn coil in order to reduce the capacitance value of a tuning capacitor (not shown) and increase the receive coil's impedance. By way of example, receive coil 518 may be placed around the substantial circumference of device 550 in order to maximize the coil diameter and reduce the number of loop turns (i.e., windings) of the receive coil 518 and the inter-winding capacitance.

Receive circuitry 510 may provide an impedance match to the receive coil 518. Receive circuitry 510 includes power conversion circuitry 506 for converting a received RF energy source into charging power for use by the device 550. Power conversion circuitry 506 includes an RF-to-DC converter 520 and may also in include a DC-to-DC converter 522. RF-to-DC converter 520 rectifies the RF energy signal received at receive coil 518 into a non-alternating power with an output voltage represented by V_{rect}. The DC-to-DC converter 522 (or other power regulator) converts the rectified RF energy signal into an energy potential (e.g., voltage) that is compatible with device 550 with an output voltage and output current represented by Vₒᵤₜ and Iₒᵤₜ. Various RF-to-DC converters are contemplated, including partial and full rectifiers, regulators, bridges, doublers, as well as linear and switching converters.

Receive circuitry 510 may further include switching circuitry 512 for connecting receive coil 518 to the power conversion circuitry 506 or alternatively for disconnecting the power conversion circuitry 506. Disconnecting receive coil 518 from power conversion circuitry 506 not only suspends charging of device 550, but also changes the “load” as “seen” by the transmitter 404 (FIG. 2).

As disclosed above, transmitter 404 includes load sensing circuit 416 that may detect fluctuations in the bias current provided to transmitter driver 424. Accordingly, transmitter 404 has a mechanism for determining when receivers are present in the transmitter's near-field.

When multiple receivers 508 are present in a transmitter's near-field, it may be desirable to time-multiplex the loading and unloading of one or more receivers to enable other receivers to more efficiently couple to the transmitter. A receiver 508 may also be cloaked in order to eliminate coupling to other nearby receivers or to reduce loading on nearby transmitters. This “unloading” of a receiver is also known herein as a “cloaking.” Furthermore, this switching between unloading and loading controlled by receiver 508 and detected by transmitter 404 may provide a communication mechanism from receiver 508 to transmitter 404 as is explained more fully below. Additionally, a protocol may be associated with the switching that enables the sending of a message from receiver 508 to transmitter 404. By way of example, a switching speed may be on the order of 100 μsec.

According to some embodiments, communication between the transmitter 404 and the receiver 508 refers to a device sensing and charging control mechanism, rather than conventional two-way communication (i.e., in band signaling using the coupling field). In other words, the transmitter 404 may use on/off keying of the transmitted signal to adjust whether energy is available in the near-field. The receiver may interpret these changes in energy as a message from the transmitter 404. From the receiver side, the receiver 508 may use tuning and de-tuning of the receive coil 518 to adjust how much power is being accepted from the field. In some cases, the tuning and de-tuning may be accomplished via the switching circuitry 512. The transmitter 404 may detect this difference in power used from the field and interpret these changes as a message from the receiver 508.

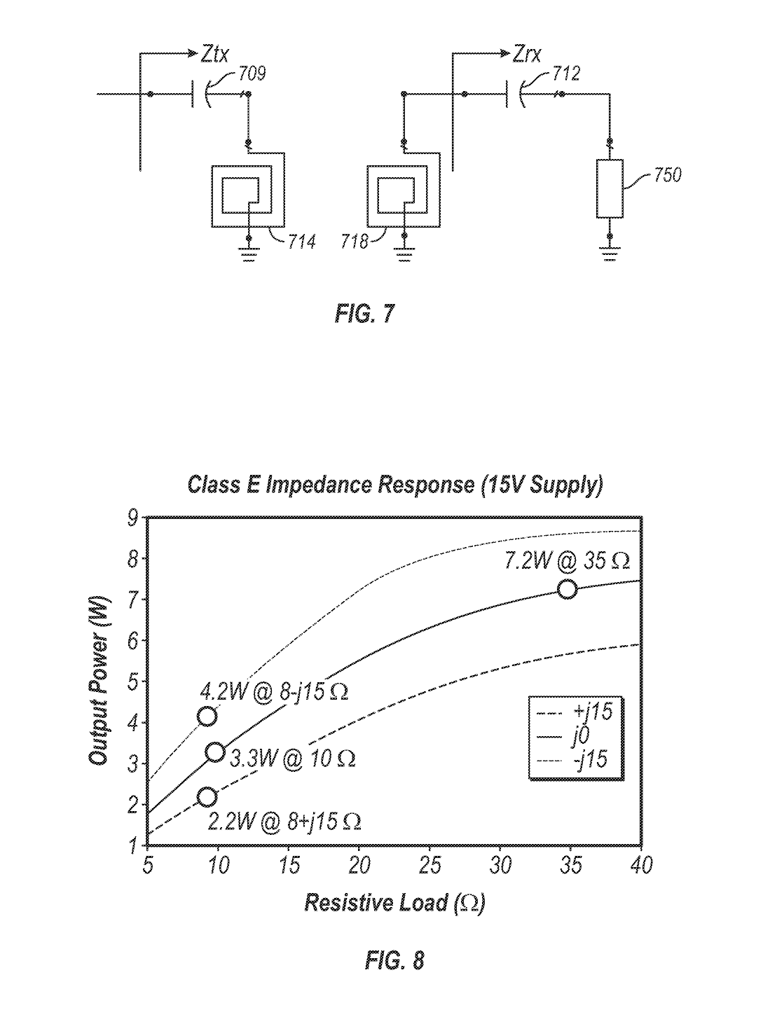

Further, the transmitter 404 may include a voltage sensor 417 coupled to the output of the driver 424. The voltage sensor 417 may be configured to detect a voltage at the output of the driver 424 and provide the detected voltage signal to the controller 415. The controller 415 may process the voltage signal to decode a message that is relayed to the transmitter 404 by a receiver in communication with the transmitter. The process of signaling via load-modulation at the receiver will be described in greater detail with reference to FIGS. 7-11 below. While illustrated as a voltage sensor 417 in FIG. 4, other types of sensors may also be used (e.g., such as a current sensor).

Receive circuitry 510 may further include signaling detector and beacon circuitry 514 used to identify received energy fluctuations, that may correspond to informational signaling from the transmitter to the receiver. Furthermore, signaling and beacon circuitry 514 may also be used to detect the transmission of a reduced RF signal energy (i.e., a beacon signal) and to rectify the reduced RF signal energy into a nominal power for awakening either un-powered or power-depleted circuits within receive circuitry 510 in order to configure receive circuitry 510 for wireless charging.

Receive circuitry 510 further includes processor 516 for coordinating the processes of receiver 508 described herein including the control of switching circuitry 512 described herein. Cloaking of receiver 508 may also occur upon the occurrence of other events including detection of an external wired charging source (e.g., wall/USB power) providing charging power to device 550. Processor 516, in addition to controlling the cloaking of the receiver, may also monitor beacon circuitry 514 to determine a beacon state and extract messages sent from the transmitter 404. Processor 516 may also adjust the DC-to-DC converter 522 for improved performance.

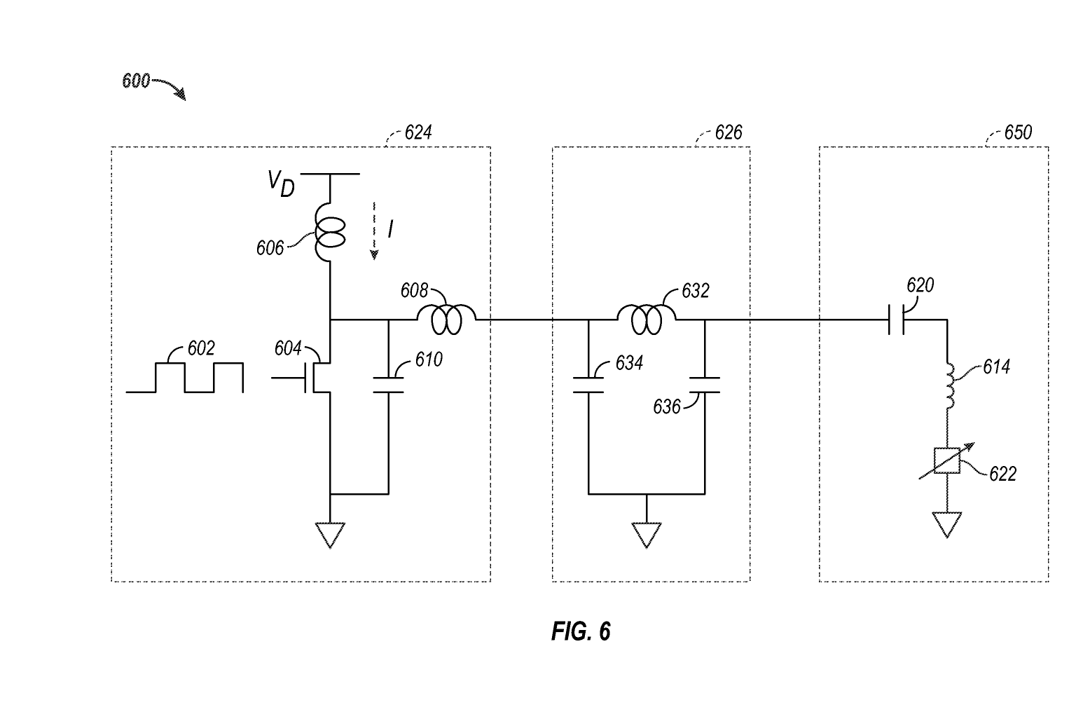

FIG. 6 is a schematic diagram of a portion of transmit circuitry 600 that may be used in the transmit circuitry 406 of FIG. 4. The transmit circuitry 600 may include a driver 624 as described above with reference to driver 424 in FIG. 4. As described above, the driver 624 may be a switching amplifier that may be configured to receive a square wave and output a sine wave to be provided to the transmit circuit 650. In some cases the driver 624 may be referred to as an amplifier circuit. The driver 624 is shown as a class E amplifier, however, any suitable driver 624 may be used in accordance with embodiments of the invention. The driver 624 may be driven by an input signal 602 from an oscillator 423 as shown in FIG. 4. The driver 624 may also be provided with a drive voltage V_{D} that is configured to control the maximum power that may be delivered through a transmit circuit 650. To eliminate or reduce harmonics, the transmit circuitry 600 may include a filter circuit 626. The filter circuit 626 may be a three pole (capacitor 634, inductor 632, and capacitor 636) low pass filter circuit 626.

The signal output by the filter circuit 626 may be provided to a transmit circuit 650 comprising a transmit coil 614. The transmit circuit 650 may include a series resonant circuit having a capacitor 620, having an associated capacitance value, and an inductance (e.g., that may be due to the inductance of the transmit coil 614 or to an additional inductive component) that may resonate at a frequency of the filtered signal provided by the driver 624. The load of the transmit circuit 650 may be represented by the variable impedance component 622. The load may be a function of a wireless power receiver 508 that is positioned to receive power from the transmit circuit 650.

While shown as a class E amplifier 624, the type of driver is not limited thereto. Further, a driver 624 may be configured to efficiently drive a load 650. The load 650 may be associated with the transmit circuit configured to wirelessly transmit power. As described above, the load presented to the driver 624 may be variable due to the number and type of wireless power receivers and may be modeled by a variable impedance component 622. The driver 624 may be driven by an input signal 602, such as an output of an oscillator 233 as shown in FIG. 2. As the load a the wireless power receiver varies due, for example, to a change in the loading conditions of a wireless power receiver, the load 650 presented to the driver 624 also varies. The driver 624 may be configured to have an output which varies based on the loading conditions presented by the load 650. For example, an output power of the driver 624 may be based on the impedance value of the load 650.

FIG. 7 illustrates a schematic diagram of a wireless power transmitter and wireless power receiver. As shown in FIG. 7, a transmit resonant circuit includes a transmit coil 714 coupled to a transmit capacitor 709 to form a resonant transmit circuit. A receive resonant circuit includes a receive coil 718 coupled to a receive capacitor 712 to form a resonant receive circuit. The receive resonant circuit may also include an impedance based on a load 750. The impedance of the load 750 may be variable and may also include both a resistive component and a reactive component. The impedance at the output of the receive coil 718, which includes the combined impedance of the receive capacitor 712 and the impedance of the load 750 may be referred to here in as Zᵣₓ, where Zᵣₓ includes a resistive component Rᵣₓ and a reactive component Xᵣₓ. An impedance as seen by the transmit resonant circuit which is coupled to the receive resonant circuit may be referred to as Zₜₓ as shown in FIG. 7. The impedance Zₜₓ may be given by equation 1 below:

$${Z}_{tx} = \frac{{ω}^{2} {M}_{12}^{2} {R}_{rx}}{{R}_{rx}^{2} + {( ω {M}_{22} + {X}_{rx} )}^{2}} + j [ ω {M}_{11} - \frac{{ω}^{2} {M}_{12}^{2} ( ω {M}_{22} + {X}_{rx} )}{{R}_{rx}^{2} + {( ω {M}_{22} + {X}_{rx} )}^{2}} ] \qquad Eq . ( 1 )$$

where Zₜₓ is the impedance at the input of the transmit resonant circuit, ω is the frequency in radians, M₁₁ is the self inductance of transmit coil 714, M₂₂ is the self inductance of receive coil 718, M₁₂ is the mutual inductance between transmit coil 714 and receive coil 718, Rᵣₓ is the resistive component of the receive resonant circuit, and Xᵣₓ is the reactive load of the receive resonant circuit.

Furthermore, if transmit coil 714 and the receive coil 718 are tuned with one another, as previously noted, the impedance Zₜₓ as seen by transmit resonant circuit and associated with receiver may be given by equation 2 below:

$${Z}_{tx} = \frac{{ω}^{2} {M}_{12}^{2}}{{R}_{rx}} \qquad Eq . ( 2 )$$

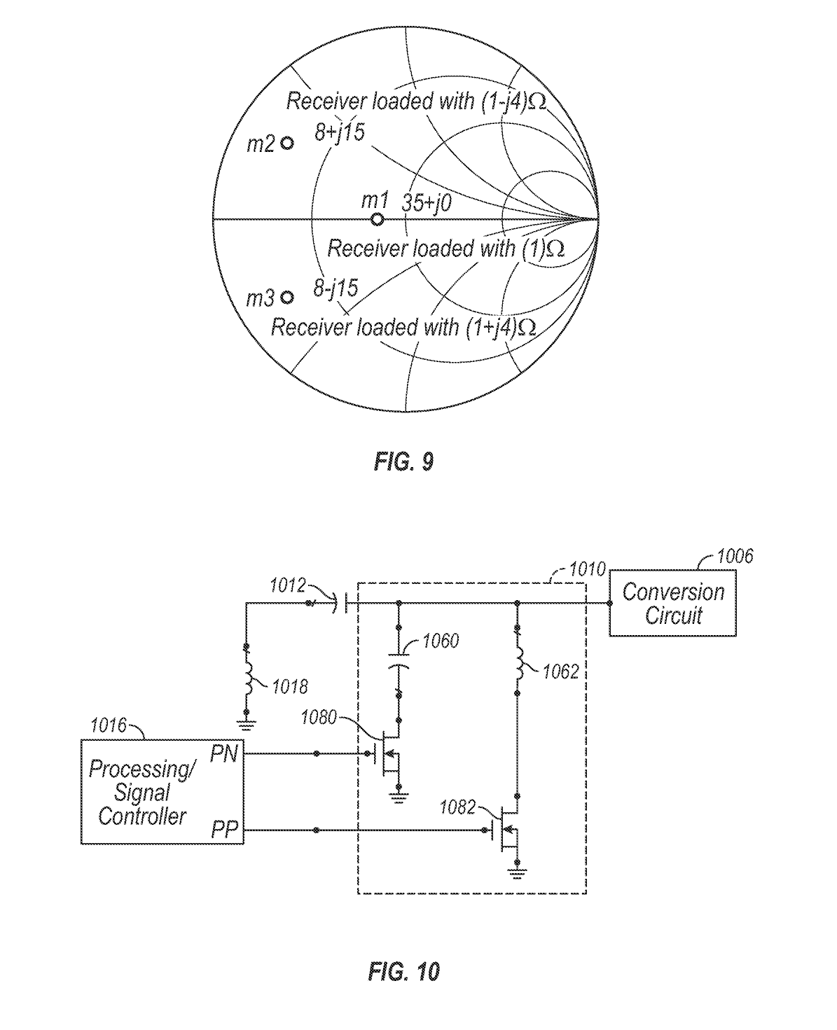

That is when the receive resonant circuit is tuned with the transmit resonant circuit, a maximum real impedance may be presented to the transmit resonant circuit. A reactively loaded receiver may present a smaller real impedance to the transmitter along with an inverse reactance shift as will be described in greater detail with reference to FIGS. 8-9 below. The examples described with reference to FIGS. 8-9 below are based on a transmit circuit and receive circuit as shown in FIG. 7 having the following values:

M₁₁: 12 μH

R1: 1Ω

M₂₂: 3 μH

R2: 1Ω

M: 200 nH

where M₁₁ is the inductance of the transmit coil 714, R1 is the loss resistance of the transmit coil 714, M₂₂ is the inductance of the receive coil 718, R2 is the loss resistance of the receive coil 718, and M is the mutual inductance of the transmit coil 714 and receive coil 718. The values presented herein are provided as an example and a person/one having ordinary skill in the art will recognize that the embodiments described herein are not limited thereto.

FIG. 8 is a plot showing transmitter power as a function of various loads. The plot of FIG. 8 shows output power for loads without reactance as illustrated by the plot labeled j0, for loads with a negative reactance as illustrated by the plot labeled −j15, and for loads with a positive reactance as illustrated by the plot labeled +j15. The output of a driver 424 of the transmitter, such as Class E amplifier, may change in response to how the receiver is loaded. For example, for a given transmit circuit and receive circuit, the plot of FIG. 8 shows that output power may be 3.3 W for a 10Ω resistive load, 4.2 W for a 8−j15Ω load and 2.2 W for a 8+j15Ω load. As the resistive component of the load (e.g., real component of complex impedance) increases, the output power of the driver 624 also increases along each plot. For example, at a resistive load of 35Ω, the output power the driver 624 Further, as the reactive component (e.g., the imaginary component of the complex impedance) changes, a corresponding change in output power of the driver 624 also changes as illustrated by the three plot lines. Therefore, the output power of the driver 624 is related to the impedance response at the transmitter given varying loads at the receiver. The driver 624 may output higher power with higher impedance. The output power of the driver 624 may decrease when the transmitter is presented with an indicative load (e.g., a positive reactance component). The output power of the driver 624 may increase when the transmitter is presented with a capacitive load (e.g., a negative reactance component). Therefore, reactively loading the receiver(s) causes a shift in impedance both real and reactive presented to the transmitter, thereby varying the output of the driver 624 in response.

FIG. 9 shows a plot illustrating examples of an impedance response of a reactively loaded receiver. As shown, m1 may correspond to a receiver loaded with 1Ω with an impedance response at the transmitter of 35+j0Ω. As shown by point m2, if a receiver is loaded with 1+j4Ω, then the impedance response at the transmitter may be 8−j15Ω. At shown by point m3, if a receiver is loaded with 1−j4Ω, then the impedance response at the transmitter may be 8+j15Ω. As shown in FIG. 9, by varying a resistive and a reactive component of an impedance at the receiver, a complex constellation of impedances (e.g., Zₜₓ) may be seen at the transmitter.

Signaling may be therefore accomplished by reactively loading the receiver. This may be detected at the transmitter, for example, using changes in the output power. As discussed above, a change in output power of the driver 624 may be detect using for example a voltage sensor (e.g., voltage sensor 417) and/or a current sensor connected to the output of the driver 624. To account for changes in output power due to reactive loading of the receiver, the driver 624 may be designed to have a desirable response (e.g., maintain a constant or target output power) with respect to the impedance swing seen at the transmitter (e.g., Zₜₓ) caused by reactively loading the receiver.

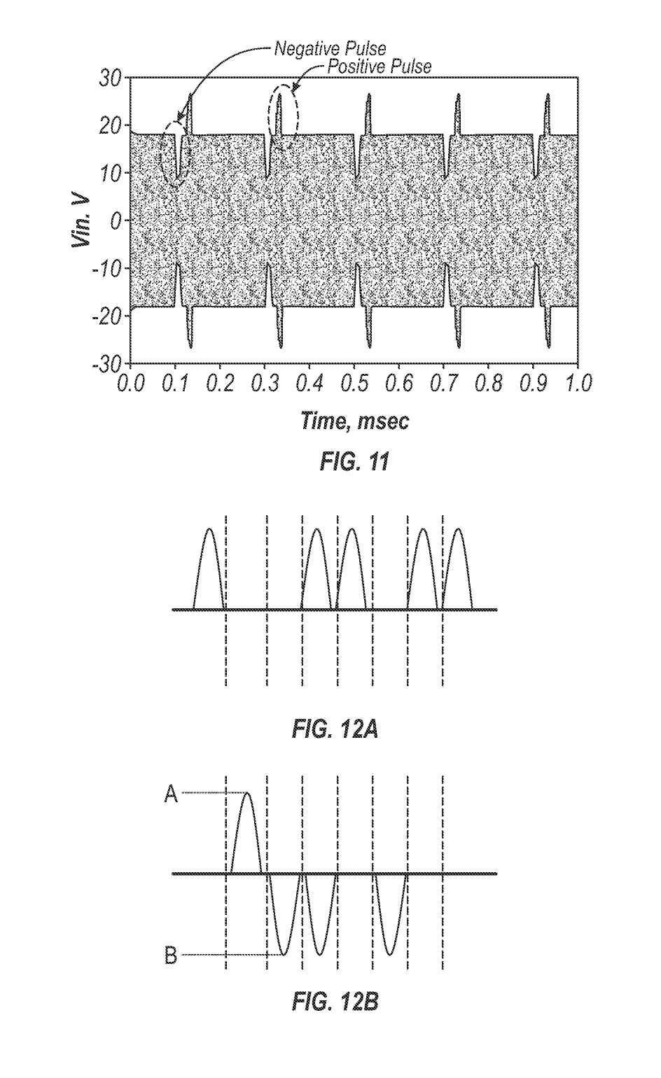

Reactively loading the receiver and detecting the resulting impedance shift (both resistive and reactive) at the transmitter may be used to communicate multi-level signaling data values to a transmitter from a receiver. As referred to herein, multi-level signaling data values are defined as signals having one or more amplitude values and/or signals having opposite polarities. According to some embodiments, multi-level signaling data values include signals having two or more states. For example, multi-level signaling data values may include signals having at least three states, including a no-pulse state, a positive polarity pulse state, and a negative polarity pulse state. Data communicated from a receiver to a transmitter may include, among other things, the temperature of the receiver, the voltage level received by the receiver, a current level induced at the receiver, specifications of the receiver device components (e.g., required voltage level), and/or status of a receiver (e.g., charge level of load, etc.). Examples of multi-level signaling data values will be described in greater detail with reference to FIGS. 11, 12B, 13B, 14B, and 14C below.

FIG. 10 shows a partial schematic diagram of a wireless power receiver according to some embodiments. The receiver may include a wireless power receive coil 1018 coupled to a receive capacitor 1012 to form a resonant circuit as described above with reference to FIGS. 1-5. The resonant circuit may be coupled to an impedance adjustment circuit 1010 configured to adjust a load impedance of the receiver as illustrated in FIG. 10. The impedance adjustment circuit 1010 may be coupled to a conversion circuit 1006 (e.g., rectifier, DC converter, etc.) which may be used to convert the received power for powering or charging a load. The impedance adjustment circuit 1010 may include one or more switches (e.g., transistor switches 1080 and 1082) which are coupled to reactive components connected to the input of the conversion circuit 1006. For example, a first switch 1080 may be connected between a ground terminal and a capacitor 1060. A gate of the first switch 1080 may be configured to receive a first control signal from a processing/signaling controller 1016. A second switch 1082 may be connected between a ground terminal and an inductor 1062. A gate of the second switch 1082 may be configured to receive a second control signal from the processing/signaling controller 1016. The processing/signaling controller 1016 may be configured to perform various control functions of the receiver and may be similar to the processing/signaling controller 515 described above with reference to FIG. 5.

Based on the first and second control signals, the receiver may be configured to communicate multi-level signaling data values to a transmitter coupled to the receiver. For example, in the system described above with reference to FIGS. 7-9, the capacitor 1060 may have a capacitance of 5.8 nF, while the inductor 1062 may have an inductance of 92 nH. When the first switch 1080 is in an ON state and the second switch 1082 is in an OFF state, a capacitance (e.g., 5.8 nF) may be switched into to the circuit to capacitively load the receiver. For the example values described with reference to FIG. 10, this may correspond to a −j4 load with nominal charging. Capacitive loading of the receiver with a −j4 load may correspond to a transmitter impedance response of 8+j15 as shown in FIG. 9. As a result the capacitive load may be used to generate a negative signaling pulse. When the second switch 1082 is an ON state and the first switch 1080 is in an OFF state, an inductance (e.g., 92 nH) may be added to the receiver impedance. For the example values described with reference to FIG. 10, this may correspond to using a +j4 load with nominal charging. Inductive loading of the receiver with a +j4 load may correspond to a transmitter impedance response of 8−j15 as shown in FIG. 9. As a result the inductive load may be used to generate a positive signaling pulse. In the embodiment described with reference to FIG. 10, a positive pulse or a negative pulse may be communicated to the transmitter to generate the multi-level data signaling values. Each of the capacitor 1060 and inductor 1062 may also have other values, or may be configured to have variable capacitance and inductance. As such, multi-level signaling data values having one or more of opposite polarities and different magnitudes may be communicated to a transmitter. The impedance adjustment circuit 1010 may include any number of switching elements coupled to resistors, inductors, and capacitors having different impedance values to communicate the multi-level signaling data values. Further, based on the design of the driver (e.g., driver 424), the positive signaling pulse may be generated through addition of a capacitive impedance at the receiver and a negative signaling pulse may be generated through addition of an inductive impedance at the receiver. Any number of variations of signaling pulses corresponding to resistive and reactive loading conditions may also be generated based on the response of the driver. Further, the above described example describes a two coil system whereby a positive reactive load at the receiver corresponds to a negative reactive component in the transmitter impedance response, while a negative reactive load at the receiver corresponds to a positive reactive component in the transmitter impedance response. Additionally, or alternatively, any number of coils may be used in the wireless power system. For example, a wireless power system may include a transmit coil, a receive coil, and a parasitic coil configured to transfer power from the transmit coil to the receive coil. In a three coil system, the sign of the reactive component of the transmitter impedance response may be the same as the sign of the reactive component of the receiver load. For example, a positive reactive load at the receiver in a three coil wireless power system may correspond to a positive reactive component in the transmitter impedance response. As a result, the polarity of the multi-level signaling data values may different in a three coil wireless power system when compared to a two coil wireless power system.

As discussed above, through operation of the first switch 1080 and the second switch 1082, a reactive load may be added to the receiver. Based on which reactive load is coupled to the receiver, changes in the impedance response of the transmitter as described above may allow for improved signaling techniques. For example, to perform signaling, the processing/signaling controller 1016 may generate an ON positive pulse control signal (PP) and an OFF negative pulse control signal (PN) to provide a pulse corresponding to a +j4 impedance change (positive pulse). Alternatively, processing/signaling controller 1016 may generate an ON negative pulse control signal (PN) and an OFF positive pulse control signal (PP) to provide a pulse with corresponding to a −j4 impedance change (e.g., a negative pulse). Other variations for generating a change in reactance through operation of any number of switches may also be used.

According to some embodiments, the pulses may be, for example, on the order of 10 μs in length with a 200 μs period, but are not limited thereto. The reception of power by a wireless power receiver from the wireless power transfer field may be interrupted during the communication of a signaling pulse to the wireless power transmitter (e.g., during the 10 μs pulse period). The wireless power receiver may be configured to continue to power or charge an associated load during this time period by receiving power from voltage stored in a capacitor of the receiver circuitry. One/a person having ordinary skill will recognize that the first switch 1080 and the second switch 1082 may be any type of appropriate electronic switch, and are not limited to FET switches as shown in FIG. 10. Further, according to some embodiments, a switch may be turned off to effectuate a change in the reactive load so that the previously switched-in element does not add to the reactance of the receiver. As such, the receiver may switch between one or more reactive loads to create a positive pulse and a negative pulse.

The transmit controller (e.g., controller 415) may be configured to decode and/or demodulate a sequence of pulses communicated by the receiver through variation of the loading conditions at the receiver by operation of the impedance adjustment circuit 1010. For example, a voltage signal may be sensed by the voltage sensor 417 and transmitted to the controller 415. The controller may include a signal processor, including for example, one or more filters and comparators (not shown) for processing the signals received from the voltage sensor 417. In some embodiments, a training sequence may be used through transmission of known pilot signals having a predetermined magnitude from the receiver to the transmitter to adjust the parameters of the signal processing operation. For example, pilot signals of different values may be sent to the transmitter to determine threshold values for use by the various filter and comparator components within the controller 415 to determine the corresponding data value of a multi-level signaling sequence of pulses.

FIG. 11 shows an envelope of an example waveform at an output of a wireless power transmitter when signaling with positive and negative pulses as described above. As shown, a first signaling data value may be detected as a drop in voltage (Vᵢₙ) at the output of a driver 624 and at the driving input of the transmit circuitry by a sensor (e.g., voltage sensor 417). The drop in voltage (Vᵢₙ) at the output of the driver 624 may correspond to a shorting of the capacitive branch of the impedance adjustment circuit 1010 at the receiver by applying an ON negative pulse (PN) control signal to the first switch 1080 and an OFF positive pulse (PP) control signal to the second switch 1082 of FIG. 10. Alternatively, a second data value may be detected as an increase in voltage output of the driver 624 due to a shorting of the inductive branch of the impedance adjustment circuit 1010 by applying an ON positive pulse (PP) control signal to the second switch 1082 and an OFF negative pulse (PN) control signal to the first switch 1080 of FIG. 10. The examples described herein correspond to the use of an inductive component to generate a positive pulse and a capacitive component to generate a negative pulse. However, the alternative arrangement is also possible based on the design of the impedance response of the driver 624 and/or signal processing or detection components.

By generating multi-level data signaling values, signaling from the receiver to the transmitter may be improved. For example, data messages may be transmitted from a receiver to a transmitter using different pulse sequences, thereby increasing the data rate and/or reducing the probability of collisions and interference during transmission of data between the receiver and the transmitter. Increasing the data rate may further reduce the time needed to communicate information to a transmitter, thereby reducing the amount of time that charging of the receiver through the wireless power transfer field is interrupted.

Further, the use of multi-level data signaling values may improve the robustness and throughput of signaling between the receiver and the transmitter (e.g., through use of additional layers of signaling and added states). In addition, an increase in throughput may be achieved through re-transmission of data signals within the same time period used for transmission in a conventional signaling system. Various examples of signaling protocol using multi-levels signaling data values for communication between a receiver and a transmitter will be described with reference to FIGS. 12A-B, 13A-B, and 14A-C below.

FIG. 12A illustrates an example of a on-off keying signaling waveform according a conventional signaling system. As illustrated in FIG. 12A, binary data (e.g., 10011011) may be transmitted using a pulse/no pulse sequence. In the example of FIG. 12A, a pulse may indicate a data value of “1” while a no-pulse may signal a data value of “0.” FIG. 12B illustrates an example of a ternary modulation waveform according to some embodiments. As illustrated in FIG. 12B, a signal may include multi-level signaling data values. In FIG. 12B, the signal includes both positive pulses having magnitude A and negative pulses having magnitude B. As illustrated in FIG. 12B, the magnitude of A and B may be equal. The positive pulse may correspond to the application of an inductive component through operation of the impedance adjustment circuit 1010, while the negative pulse may correspond to the application of a capacitive component through operation of the impedance adjustment circuit as discussed above. As illustrated in FIG. 12B, ternary data (e.g., corresponding to one of three data values) may be transmitted. For example, a data value of 0 may correspond to a no-pulse period, a data value of 1 may correspond to a positive pulse having magnitude A and a data value of 2 may correspond to a negative pulse having a magnitude of B such that the data transmitted corresponds to a ternary signal having data values 012202. As a result, the same binary data 10011011 may be transmitted with fewer pulses using a ternary signaling protocol as ternary data 012202 as shown in FIG. 12B.

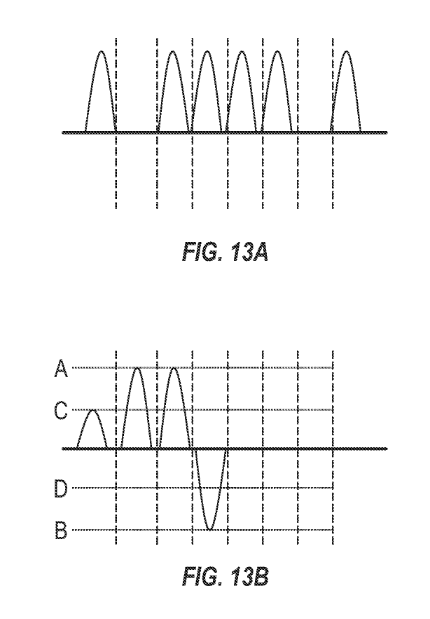

FIG. 13A illustrates another example of a on-off keying signaling waveform according a conventional signaling system. As illustrated in FIG. 13A, binary data (e.g., 10111101) may be transmitted using a pulse/no pulse sequence as described above with reference to FIG. 12A. FIG. 13B illustrates an example of a quinary modulation waveform according to some embodiments. As shown in FIG. 13B, data may be transmitted using one of four possible states A-D along with a no-pulse. For example, a no-pulse may correspond to a data value 0, a positive pulse having magnitude C may correspond to a data value of 1, a positive pulse having a magnitude of A may correspond to a data value 2, a negative pulse having magnitude D may correspond to a data value of 3, and a negative pulse having a magnitude of B may correspond to a data value 2. As shown in FIG. 13B, the same binary data represented in FIG. 13A (e.g., 10111101) may be represented as quinary data 1224 using the multi-level data signaling values and quinary protocol shown in FIG. 13B.

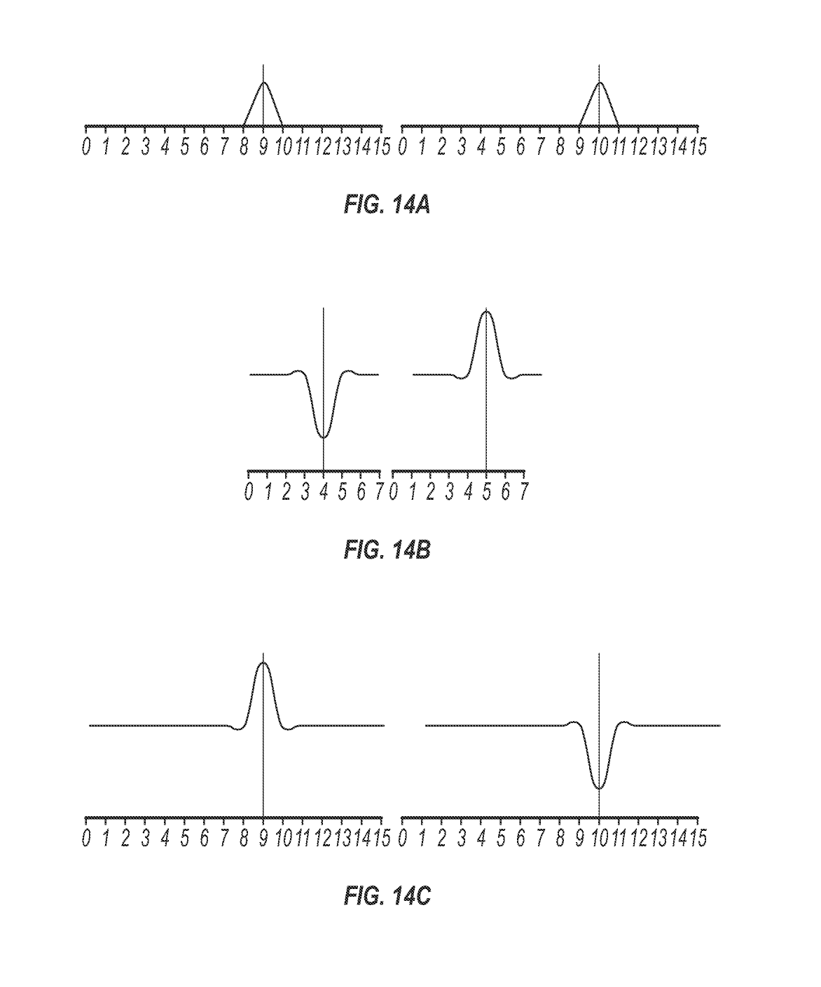

FIG. 14A illustrates an example of a pulse position modulation signaling waveform according a conventional signaling system. As shown in FIG. 14A binary data having a value of 10011010 may be communicated to a transmitter using two symbols transmitted during a 16 time slot wide transmission window. For example, as shown in FIG. 14A, a pulse may be communicated during time slot 9 in a first window, and during time slot 10 during a second window, thereby generating hexadecimal data 9A (corresponding to binary data 10011010). FIG. 14B illustrates an example of a binary pulse position modulation waveform according to some embodiments. A pulse position modulation protocol according to FIG. 14B may include the use of a positive pulse and a negative pulse. A positive pulse may be decoded as 2*X, while a negative pulse may be decoded as (2*Y+1), where X correspond to the time slot of the positive pulse and Y corresponds to the time slot of the negative pulse. As shown in FIG. 14B, the same hexadecimal data (e.g., 9A) may be communicated by communicating a negative pulse during time slot 4 of window 1 and a positive pulse during time slot 5 of window 2. As a result, the same hexadecimal data (9A) may be communicated to the transmitter using half the window size (e.g., 8 time slots) as that of the example shown in FIG. 14A.

Multi-level signaling may also be used to increase the robustness and throughput of messaging between a receiver and a transmitter. FIG. 14C illustrates another example of a differential pulse position modulation waveform according to some embodiments. As shown in FIG. 14C, the same hexadecimal data described with reference to FIG. 14A (e.g., hexadecimal data 9A) may be communicated by the receiver to the transmitter using a positive and a negative pulse. Signal processing at the transmitter (e.g., through operation of controller 415) may be configured to check the polarity (and/or magnitude) of incoming multi-level data signaling values. For example, in the embodiment of FIG. 14C, each subsequent pulse may have inverted polarity to serve as a parity check of the transmitted data message. The transmitter may determine that an error in the data message is present if two consequitive positive or negative pulses are received by the transmitter.

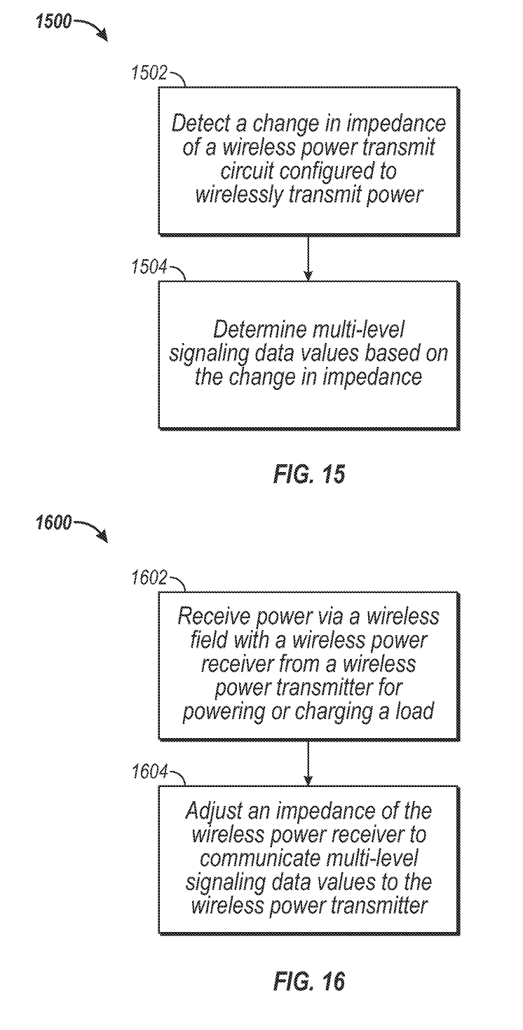

As described above, a transmitter may be configured to receive messages communicated by a received via a wireless power transfer field. FIG. 15 illustrates a flow chart of an example method for receiving multi-level signaling data values according to some embodiments. As shown in FIG. 15, the method 1500 includes detecting a change in impedance of a wireless power transmit circuit configured to wireless transmit power as shown by block 1502. The method also includes determining multi-level signaling data values based on the change in impedance as shown by block 1504.

Further, as described above, a receiver may be configured to communicate multi-level data signaling values by changing a loading condition of the receiver. FIG. 16 illustrates a flow chart of an example method for generating multi-level signaling data values according to some embodiments. As shown in FIG. 16, the method 1600 includes receiving power via a wireless power receiver from a wireless power transmitter for powering or charging a load as shown in block 1602. The method further includes adjusting an impedance of the wireless power receiver to communicate multi-level signaling data values to the wireless power transmitter as shown by block 1604.

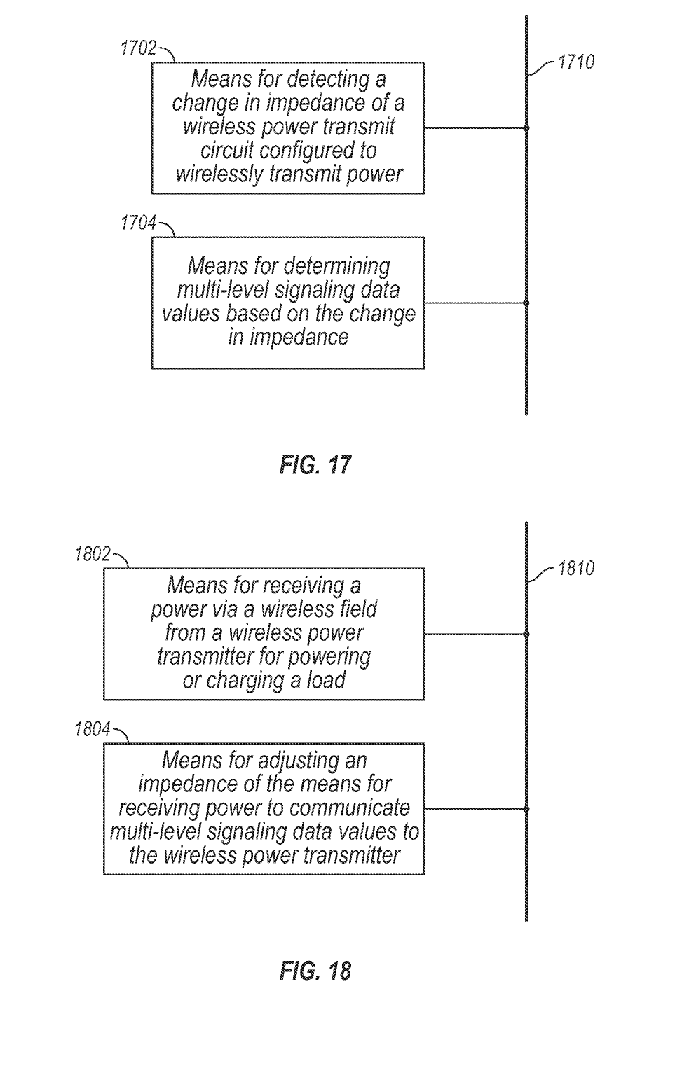

FIG. 17 is a functional block diagram of an apparatus for receiving multi-level signaling data values according to some embodiments. The apparatus shown in FIG. 17 may correspond to a wireless power transmitter (e.g., transmitter 404 as described above with reference to FIG. 4). As illustrated in FIG. 17, the apparatus may include a means for detecting a change in impedance of a wireless power transmit circuit configured to wirelessly transmit power as shown by block 1702. For example, the means for detecting 1702 a change in impedance may include a sensor, such as a voltage sensor 417 coupled to a driver 624 as described above with reference to FIG. 4. The apparatus also includes a means for determining multi-level signaling data values based on the change in impedance as shown by block 1704. The means for determining 1704 multi-level signaling data values may correspond to a transmit controller (e.g., controller 415) including a signal processor having one or more filters and comparators as described above. The means for determining 1704 multi-level signaling data values may be configured to communicate with the means for detecting 1702 a change in impedance through a communication or control bus 1710.

FIG. 18 is a functional block diagram of an apparatus for communicating multi-level signaling data values according to some embodiments. The apparatus shown in FIG. 18 may correspond to a wireless power receiver (e.g., transmitter 508 as described above with reference to FIG. 5). As illustrated in FIG. 18, the apparatus may include a means for receiving power via a wireless field from a wireless power transmitter for powering or charging a load as shown by block 1802. For example, the means for receiving power 1802 may correspond to a receive resonant circuit having, for example, a receive coil 718 coupled to a receive capacitor 712 and forming a receive resonant circuit as described above with reference to FIG. 7. The apparatus also includes a means for adjusting an impedance of the means for receiving power to communicate multi-level signaling data values to the wireless power transmitter as shown by block 1804. The means adjusting an impedance 1804 may correspond to an impedance adjustment circuit 1010 as described above. The means for receiving power 1802 may be configured to communicate with the means for adjusting an impedance 1804 through a communication or control bus 1810.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments of the invention.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

Various modifications of the above described embodiments will be readily apparent, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A wireless power receiver configured to receive power from and communicate with a wireless power transmitter via a wireless field, the wireless power receiver comprising:
a resonant circuit having a receiver impedance capable of being sensed by the transmitter; and
an impedance adjustment circuit configured to adjust the receiver impedance to transmit multi-level signaling data values to the transmitter.

2. The wireless receiver of claim 1, wherein the impedance adjustment circuit is configured to adjust an inductor or a capacitor or both to adjust the receiver impedance.

3. The wireless receiver of claim 1, wherein the receiver includes a reactive component and a resistive component, wherein the reactive component has one of a positive value and a negative value, and wherein the impedance adjustment circuit is configured to vary the reactive component between the positive value and the negative value to transmit the multi-level signal data values to the wireless power transmitter.

4. The wireless receiver of claim 1, wherein the impedance adjustment circuit is configured to generate a complex constellation of receiver impedances.

5. The wireless receiver of claim 1, wherein the impedance adjustment circuit includes:
a first adjustment circuit including a first reactive element, the first circuit being configured to be selectively coupled to the resonant circuit; and
a second adjustment circuit including a second reactive element, the second circuit being configured to be selectively coupled to the resonant circuit, the first reactive element being different than the second reactive element, and wherein the wireless power receiver further comprises:
a processor configured to control selective coupling of the first and second adjustment circuits to the resonant circuit.

6. The wireless power receiver of claim 5, wherein coupling the first adjustment circuit to the resonant circuit generates a first waveform corresponding to a first signaling data value, and wherein coupling the second circuit to the resonant circuit generates a second waveform corresponding to the second signaling value, wherein the first waveform is different than the second waveform, and wherein the processor is configured to control selective coupling to generate a data signal including the first and second waveforms.

7. The wireless power receiver of claim 6, wherein the data signal is part of a data message.

8. The wireless power receiver of claim 5, wherein the first reactive element comprises a capacitive element, and wherein the impedance is configured to have a negative reactance value when the first adjustment circuit is coupled to the resonant circuit.

9. The wireless power receiver of claim 5, wherein the second reactive element comprises an inductive element, and wherein the impedance is configured to have a positive reactance value when the second adjustment circuit is coupled to the resonant circuit.

10. The wireless power receiver of claim 5, wherein the processor is configured to selectively couple the first adjustment circuit to the resonant circuit for a first determined period of time and to selectively couple the second adjustment circuit to the resonant circuit for a second determined period of time.

11. The wireless power receiver of claim 5, wherein the first adjustment circuit and the second adjustment circuit include variable reactance components.

12. The wireless power receiver of claim 1, wherein the impedance adjustment circuit is configured to adjust the receiver impedance to transmit the multi-level signaling data values while the resonant circuit continues to receive power for powering or charging a load.

13. A method comprising:
receiving power via a wireless field with a wireless power receiver from a wireless power transmitter for powering or charging a load; and
adjusting an impedance of the wireless power receiver to communicate multi-level signaling data values to the wireless power transmitter.

14. The method of claim 13, further comprising:
selectively coupling a first adjustment circuit including a first reactive element to the resonant circuit; and
selectively coupling a second adjustment circuit including a second reactive element to the resonant circuit, the first reactive element being different than the first reactive element.

15. The method of claim 13, wherein adjusting an impedance of the wireless power receiver includes generating a complex constellation of wireless power receiver impedances.

16. The method of claim 13, wherein adjusting an impedance of the wireless power receiver includes adjusting the impedance to transmit the multi-level signaling data values while the wireless power receiver continues to receive power for powering or charging the load.

17. A wireless power receiver, comprising:
means for receiving power via a wireless field with a wireless power receiver from a wireless power transmitter for powering or charging a load; and
means for adjusting an impedance of the wireless power receiver to communicate multi-level signaling data values to the wireless power transmitter.

18. The wireless power receiver of claim 17, wherein the means for receiving power comprises an resonant circuit, and wherein the means for adjusting an impedance comprises a first adjustment circuit including a first reactive element and a second adjustment circuit including a second reactive element.

19. The apparatus of claim 17, wherein the means for adjusting an impedance of the wireless power receiver is configured to adjust the impedance to transmit the multi-level signaling data values while the means for receiving power continues to receive power for powering or charging the load.

20. A wireless power transmitter configured to transmit power to and communicate with a wireless power receiver via a wireless field, the wireless power receiver having an resonant circuit having a wireless power receiver impedance, the wireless power transmitter comprising:
an impedance detection circuit configured to detect a change in the wireless power receiver impedance; and
a processor configured to determine multi-level signaling data values based on the change in the wireless power receiver impedance.

21. The wireless power transmitter of claim 20, wherein the processor is configured to decode a data message based on at least one of a polarity and an amplitude of the multi-level signaling data values.

22. The wireless power transmitter of claim 20, wherein the multi-level signaling data values form a data message including alternating positive and negative signaling data values, and wherein the processor is configured to determine an error in the data message if two signaling values having the same polarity are consecutively present in the data message.

23. The wireless power transmitter of claim 20, wherein the multi-level signaling data values correspond to a multiphase pulse.

24. The wireless power transmitter of claim 20, wherein the change in the wireless power receiver impedance includes a change in a reactive component and a resistive component.

25. The wireless power transmitter of claim 20, further comprising a driver configured to drive a transmit coil, and wherein the impedance detection circuit includes a sensor coupled to the driver.

26. The wireless power transmitter of claim 25, wherein the driver comprises a Class-E amplifier.

27. A method comprising:
detecting a change in impedance of a wireless power transmit circuit configured to wirelessly transmit power; and
determining multi-level signaling data values based on the change in impedance.

28. The method of claim 27, further comprising decoding a data message based on at least one of a polarity and an amplitude of the multi-level signaling data values.

29. The method of claim 27, wherein the multi-level signaling data values form a data message including alternating positive and negative signaling data values, the method further comprising determining an error in the data message if two signaling values having the same polarity are consecutively present in the data message.

30. A wireless power transmitter, comprising:
means for detecting a change in impedance of a wireless power transmit circuit configured to wirelessly transmit power; and
means for determining multi-level signaling data values based on the change in impedance.

31. The wireless power transmitter of claim 30, wherein the means for detecting a change in impedance of a wireless power transmitter comprises an impedance detection circuit, and wherein the means for determining multi-level signaling data values comprises a processor.

32. The wireless power transmitter of claim 30, further comprising a driver configured to drive a transmit coil, and wherein the impedance detection circuit includes a sensor coupled to the driver.
